(19) United States
(12) Patent Application Publication
(10) Pub. No.: US 2025/0245248 A1
(43) Pub. Date: Jul. 31, 2025

(54) SEMANTIC SEARCHING OF STRUCTURED DATA USING GENERATED QUERY SPACES

(71) Applicant: Salesforce, Inc., San Francisco, CA (US)

(72) Inventors: Avi Brenner, Phoenix, AZ (US); Ka Man Mary Wong, Vancouver (CA); Vincent Tang, New York, NY (US); Irene Fung, New Westminster (CA); Derrick Wan, Vancouver (CA)

(21) Appl. No.: 18/427,014

(22) Filed: Jan. 30, 2024

(51) Int. Cl. G06F 16/332; G06F 16/338; G06F 40/30; G06F 40/40

(52) U.S. Cl. CPC G06F 16/3329; G06F 16/338; G06F 40/30; G06F 40/40

(57) ABSTRACT

Methods, systems, apparatuses, devices, and computer program products are described. An application server or a data processing system may generate a set of candidate natural language queries that correspond to a data object (e.g., document, report, assert) based on inputting a set of metadata associated with the data object into a large language model (LLM). The system may embed the candidate natural language queries into a first set of vectors, where a query space may include a collection of the first set of vectors related to the data object. In addition, the system may embed a natural language query received from a user into a second vector. The system may perform a vector-space comparison of the second vector to the first set of vectors or the query space, and retrieve a data object associated with the natural language query based on the comparison.

### FIELD OF TECHNOLOGY

The present disclosure relates generally to database systems and data processing, and more specifically to semantic searching of structured data using generated query spaces.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

The cloud platform may support systems used to perform semantic searches of structured data such as assets (e.g., documents, reports, and the like). In some examples, discovery of assets related to each other may be handled semantically by attempting to match key phrases from existing assets of the user and a query for the relevant assets being searched for. However, as keyword-based searches tend to lose context when searching for structured data, such search processes may be complicated for structured data. In addition, semantic searches may rely heavily on specific and guided query phrases from the user. If a user fails to provide specific and clear enough query phrases, the search may yield inaccurate or undesired results.

### BRIEF DESCRIPTION OF THE DRAWINGS

FIG. 1 illustrates an example of a data processing system that supports semantic searching of structured data using generated query spaces in accordance with aspects of the present disclosure.

FIG. 2 shows an example of a computing architecture that supports semantic searching of structured data using generated query spaces in accordance with aspects of the present disclosure.

FIG. 3 shows an example of embedded queries that support semantic searching of structured data using generated query spaces in accordance with aspects of the present disclosure.

FIG. 4 shows an example of document retrieval that supports semantic searching of structured data using generated query spaces in accordance with aspects of the present disclosure.

FIG. 5 shows an example of a process flows that supports semantic searching of structured data using generated query spaces in accordance with aspects of the present disclosure.

FIG. 6 shows a block diagram of an apparatus that supports semantic searching of structured data using generated query spaces in accordance with aspects of the present disclosure.

FIG. 7 shows a block diagram of a data processor that supports semantic searching of structured data using generated query spaces in accordance with aspects of the present disclosure.

FIG. 8 shows a diagram of a system including a device that supports semantic searching of structured data using generated query spaces in accordance with aspects of the present disclosure.

FIGS. 9 through 12 show flowcharts illustrating methods that support semantic searching of structured data using generated query spaces in accordance with aspects of the present disclosure.

### DETAILED DESCRIPTION

Some systems may support semantic searching of structured data. In some examples, a data store may store a large collection of documents (e.g., analytical assets, reports, and other structured data), and a user may perform some document retrieval techniques to find relevant documents to answer specific queries. As such documents may include significant amounts of data (thus making it inefficient to store them in whole), the documents may be represented by a structured and compact description (e.g., a set of metadata describing the organization and intent of the document).

According to one or more aspects of the present disclosure, the system may support techniques for asymmetric document retrieval, which may include representing structured documents (e.g., report metadata) with embeddings of relevant, synthetic queries (also referred to herein as a query space corresponding to a document), which may be generated via general-purpose large language models (LLMs) from prior natural language queries, report formulas, or both.

Specifically, each data object in a data store may correspond to a set of metadata. The set of metadata may be of a structured format (e.g., a JavaScript object notation (JSON) format), which the system may convert to a serialized (e.g., unstructured) format for inputting into an LLM. The system may input the set of metadata into the LLM and generate a set of candidate natural language queries corresponding to the data object. The candidate natural language queries may be examples of potential and plausible queries that may have been directed towards a given document. The system may embed the candidate natural language queries into a first set of vectors. In addition, the system may receive a natural language query (e.g., from a user via a user device) and embed the natural language query into a second vector. In some examples, a collection of embedded candidate natural language queries may make up a query space corresponding to the data object. The system may perform a vector-space comparison of the second vector to the first set of vectors to determine which query space the natural language query received from the user is most related to. The system may identify the data object associated with the received natural language query based on the vector-space comparison and cause for display an indication of the data object (e.g., at a user device).

Aspects of the disclosure are initially described in the context of an environment supporting an on-demand database service. Aspects of the disclosure are then described in the context of computing architectures, embedded queries, document retrieval, and process flows. Aspects of the disclosure are further illustrated by and described with reference to apparatus diagrams, system diagrams, and flowcharts that relate to semantic searching of structured data using generated query spaces.

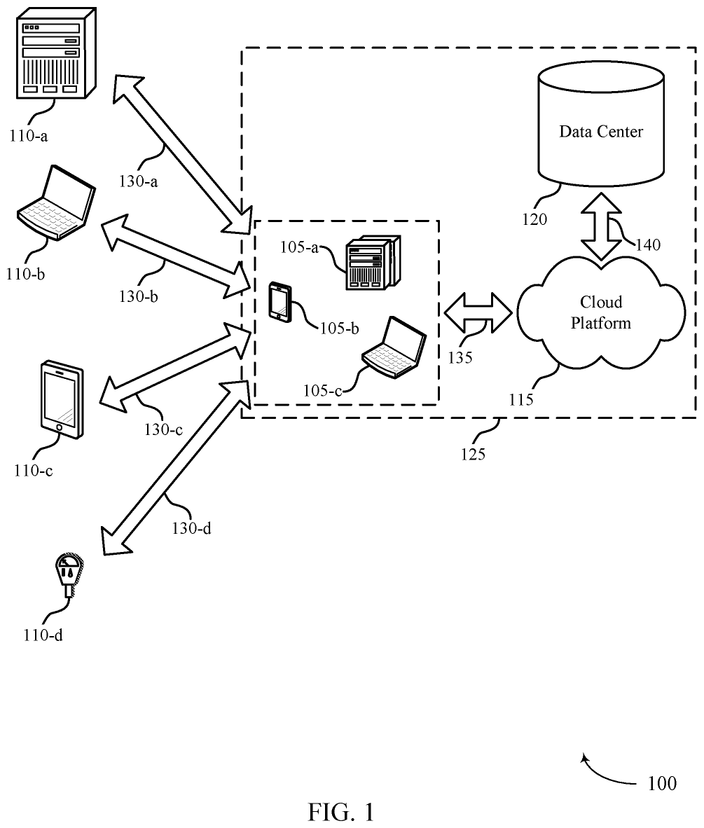

FIG. 1 illustrates an example of a system 100 for cloud computing that supports semantic searching of structured data using generated query spaces in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a. 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some cases, a device (e.g., any component of subsystem 125, such as a cloud client 105, a server or server cluster associated with the cloud platform 115 or data center 120, etc.) may perform procedures relating to the discovery of a document. For example, a data center 120 (e.g., a data store) may store a set of documents, including reports and other assets. Each document may correspond to a highly-structured, compact description or set of metadata (e.g., a JSON file) that describes the overall intent and/or scope of the document and is much smaller than the document. Because the entire document may be too large to embed and search (e.g., which would lead to excessive resource consumption and searching inefficiencies), the set of metadata may be used for searching. However the limited scope of the set of metadata may limit how much information is available for retrieval.

Specifically, a document itself may not be embedded and used for searching because it may be in a format that is not usable by an LLM, which may be used to facilitate the searching. For example, the data in the document may be dynamic (e.g., may be changed) and structured (e.g., in a tabular, spreadsheet form). Conversely, LLMs may be trained on unstructured text (e.g., natural language strings) as opposed to tabular data. An LLM trained using unstructured text may be unable to identify a document based on structured text. Thus, embedding the document itself may result in insufficient or failed searches. In addition, the amount of data in the document may be too large to embed meaningfully. Some systems may divide up the document and embed it in portions to describe the larger document. However, this may impact the meaning of the document and complicate the query language required to retrieve the document.

In addition, traditional semantic searching may include encoding queries (Q) and documents into embeddings (E), which may map vocabulary into a latent space W (e.g., E:Q to W). This may be accomplished using a bi-encoded architecture in which queries and documents may be encoded independently. An embedding vector E_{D}(q) may be compared to other embedding vectors with a distance metric d: W×W→R (e.g., cosine similarity). In the absence of large training datasets, however, this approach may be ill-suited for asymmetric search of dynamic documents. That is, not only may a single document address or answer multiple semantically distinct queries, a document's metadata also may not be semantically close enough to a query for accurate retrieval. As such, it may be unrealistic for models to perform retrieval tasks with different search intents and query formulations.

In contrast, the data processing system 100 may support techniques for semantic searching of structured data using generated summaries. Specifically, the described techniques may support semantic searching of structured data using generated query spaces. In some implementations, each data object in a data store may correspond to a set of metadata. The set of metadata may be of a structured format (e.g., a JSON format), which the system may convert to a serialized (e.g., unstructured) format for inputting into an LLM. The system may input the set of metadata into the LLM and generate a set of candidate natural language queries corresponding to the data object. The candidate natural language queries may reflect hypothetical queries that may be directed towards a given document. The system may embed the candidate natural language queries into a first set of vectors. In addition, the system may receive a natural language query (e.g., from a user via a user device) and embed the natural language query into a second vector. In some examples, a collection of embedded candidate natural language queries may make up a query space corresponding to the data object. The system may perform a vector-space comparison of the second vector to the first set of vectors to determine which query space the natural language query received from the user is most related to. The system may identify the data object associated with the received natural language query based on the vector-space comparison and cause for display an indication of the data object (e.g., at a user device).

The techniques described herein for semantic searching of structured data using generated query spaces may result in one of the following potential improvements. In some examples, the described techniques may improve the accuracy and efficiency of database searching by enabling query-based searches, leveraging an LLM, for data that is inherently structured. As a result, users may engage with a search or discovery process in a natural way without having to rely on specific and accurate keywords in a query. In addition, the described techniques may improve computational efficiency, reduce memory and power usage, and improve the speed and accuracy of querying. For example, the described techniques may support storing and searching structured, compact descriptions (e.g., metadata) of a document rather than an entire document itself, which may reduce memory and power consumption by physically reducing the amount of data being stored. In addition, as the generated candidate natural language queries may be based on these structured, compact descriptions, the generated candidate natural language queries may improve computational efficiency by improving document retrieval performance. The generated candidate natural language queries may improve accuracy and speed of the querying, thus improving user experience.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

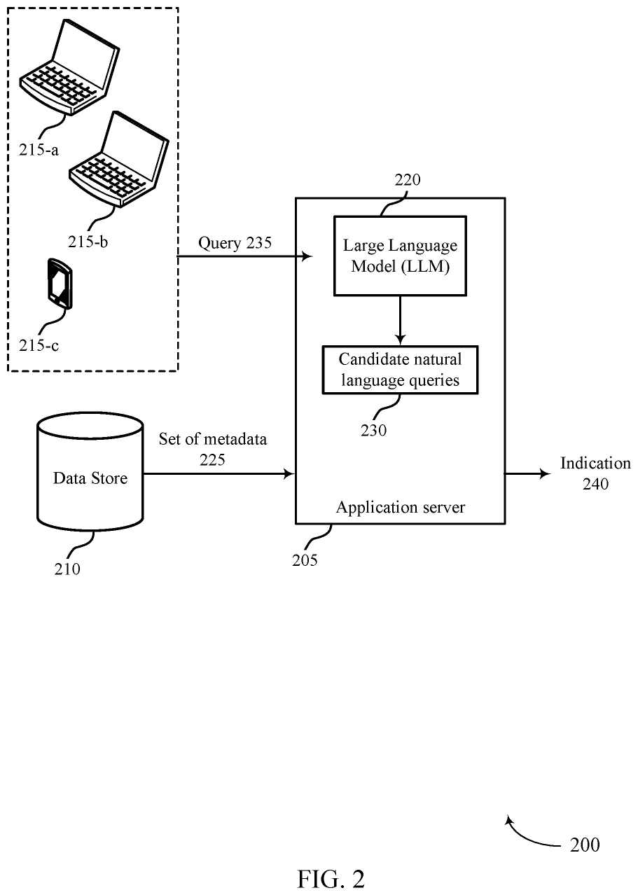

FIG. 2 shows an example of a computing architecture 200 that supports semantic searching of structured data using generated query spaces in accordance with aspects of the present disclosure. The computing architecture 200 may include an application server 205 (e.g., a device), a data store 210, and one or more user devices 215 (e.g., user device 215-a, user device 215-b, and user device 215-c), which may be examples of corresponding devices described herein with reference to FIG. 1. In some cases, the functions performed by the application server 205 may instead be performed by a component of the data store 210, the user devices 215, or some other data processing system. In some examples, the application server 205 may support communication with an external server. In addition, the user devices 215 may support an application for semantic searching of structured data, and the user devices 215 in combination with the external server and the application server 205 may support using an LLM 220 to generate candidate natural language queries and perform the semantic searching of the structured data.

The data store 210 may store a set of documents, including reports and other assets. Each document may correspond to a highly-structured, compact description or a set of metadata 225 that describes a set of attributes associated with the document (e.g., knowledge articles, help files) or a data object. In some cases, the set of metadata 225 may describe the overall intent and organization of the document rather than the data included in the document itself. For example, the set of metadata 225 may include fields corresponding to a uniform resource locator (URL) associated with the document, a short description of the document, a document type, or an owner of the document or corresponding account, among any other numerous fields that may describe the information of the document. In some examples, the set of metadata 225 may be in a first structured format such as a JSON file.

As an LLM may be trained using unstructured data (and thus may process unstructured data more effectively than structured data), a system may convert the set of metadata 225 to a serialized format. The serialized format may be unstructured (e.g., a string of characters). In some examples, the set of metadata 225 in the serialized format may be input into the LLM 220, and the LLM 220 (e.g., a general-purpose LLM, a generative pre-trained transformer (GPT) or a macro pertaining to query generation model) may generate a set of candidate natural language queries 230 corresponding to the data object. The candidate natural language queries 230 may be synthetic queries. In some implementations, using query expansion, synthetic queries may be indirectly created by using general-purpose LLMs to pseudo-documents with few-shot prompts. Synthetic queries may be directly expanded from existing queries.

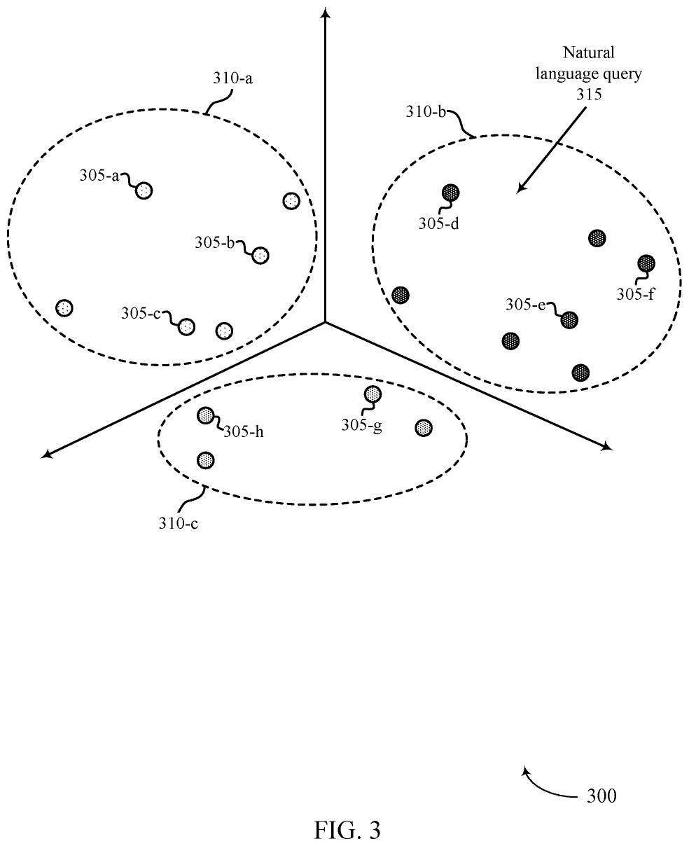

The candidate natural language queries 230) may represent plausible and relevant queries q_{syn} for documents dₜ. Different examples of candidate natural language queries 230 may be derived based on actual natural language queries, report (e.g., document) formulas, or both. In some examples, the synthetic queries may include fragments or portions of user queries, which may make the search asymmetric. For example, the LLM 220 may produce synthetic queries such as “win loss ratio,” “annual pipeline value,” or “expected close dates” when prompted with metadata for a document titled “Opportunities.” In another example, the LLM 220 may produce queries such as “top accounts” or “distribution by accounts by region” when prompted with a metadata for a document titled “Accounts.” The candidate natural language queries 230) may reflect potential and plausible queries that may be directed toward a given document or data object. Additional examples of candidate natural language queries 230 may are described herein with reference to FIG. 3.

In some implementations, the application server 205 may generate a prompt (e.g., based on a user input) indicating the set of metadata 225 to the LLM 220, and the LLM 220 may generate the candidate natural language queries 230 according to the prompt. For example, the prompt may indicate that the LLM 220 is to use the set of metadata 225 to generate synthetic queries for a corresponding data object.

Additionally, the application server 205 may apply consistency filtering to remove noisy queries from the set of candidate natural language queries 230. For example, the LLM 220 may be prompted to predict whether a generated query q_{syn} of the candidate natural language queries is relevant to a document dₜ (e.g., the data object) from which it was generated. In some examples, the consistency filtering may include matching each of the candidate natural language queries 230 to the data object. For example, if a data object is a document related to Opportunities, a first candidate natural language query may recite “what is my field pipeline?” and a second candidate natural language query may recite “how many apples are in the refrigerator?” The application server 205 may determine that the first candidate natural language query matches the document and the second candidate natural language query does not match the document and thus, may filter out the second candidate natural language query from the candidate natural language queries 230.

After using the LLM 220 to generate the candidate natural language queries 230, the application server 205 may embed the candidate natural language queries into a first set of vectors. A collection or set of embeddings associated with a data object or document I) may be interpreted as a query space corresponding to the data object. Assuming an embedding space associated with the LLM is semantically continuous and semantically interpolative, a query space may include all possible relevant queries for that data object. The data object itself may be excluded from the query space (e.g., not embedded). As such, the query space may include generated synthetic queries associated with a data object, which may be more computationally efficient than storing the entire data object itself.

The application server 205 may receive a natural language query 235 from a user via a user device 215. In some examples, the natural language query 235 may be a search for a data object corresponding to the set of metadata 225. The application server 205 may embed the natural language query 235 into a second vector. In some cases, the applications server 205 may embed the queries and generate the first set of vectors and the second vector using an embedding model M. Additionally, the application server 205 may store the first set of vectors in a vector database.

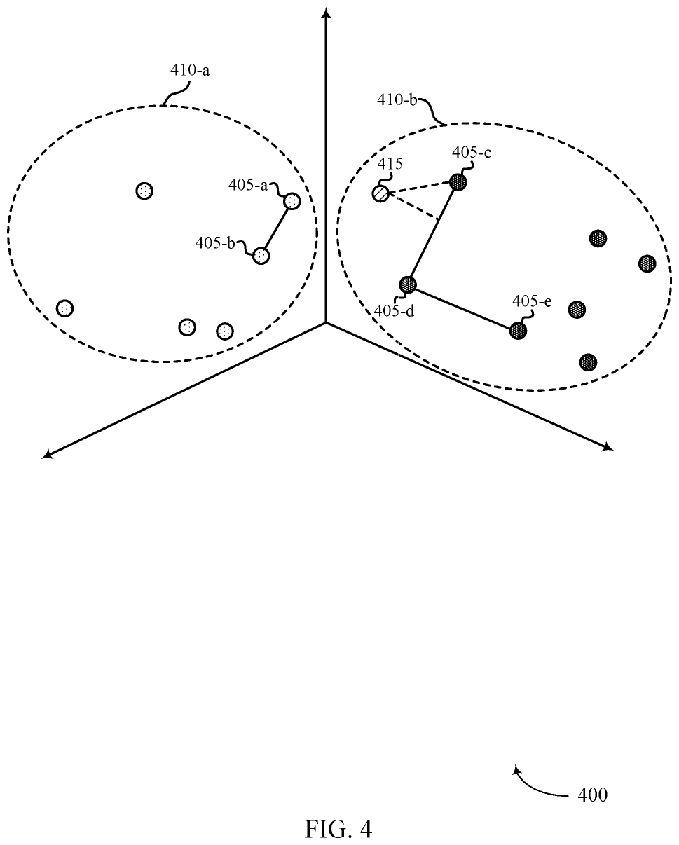

Because each data object of the data store 210 is represented by a collection of embedded candidate natural language queries 230 rather than a single embedding, the application server 205 may compare a specific embedded candidate natural language query with a query space of the document to improve document retrieval. That is, the application server 205 may perform a vector-space comparison of the second vector to the first set of vectors and select a document corresponding to the natural language query 235 based on the comparison. Techniques for the vector-space comparison are described herein with reference to FIG. 4. In addition, the application server 205 may display an indication 240 of the data object that is related to the natural language query 235.

By representing documents and data objects using these query subspaces instead of a single document embedding, a user may retrieve documents with improved granularity and accuracy. In addition, the described techniques may increase a surface area associated with a document for query matching (e.g., K query points for each document rather than just one).

FIG. 3 shows an example of embedded queries 300 that support semantic searching of structured data using generated query spaces in accordance with aspects of the present disclosure. The embedded queries 300 may implement or be implemented by aspects of the data processing system 100 and the computing architecture 200. For example, the embedded queries 300 may include a set of embedded candidate natural language queries 305, where the queries themselves may be generated by an LLM based on a set of metadata associated with a data object (e.g., document). As such, the embedded queries 300 may represent embedded synthetic or hypothetical queries 305 that may be used to search for the particular data object.

The candidate natural language queries generated by the LLM may represent synthetic queries or realistic questions a user may indicate about a given data object. The LLM may generate K candidate natural language queries per data object and as such, there may be K embedded queries 305 per data object. A collection or set of related embedded queries 305 corresponding to the data object may be referred to herein as a query space 310. For example, a query space 310-a may be associated with “Accounts”-type documents. The query space 310-a may include an embedded query 305-a “number of accounts by industry,” an embedded query 305-b “unique accounts,” and an embedded query 305-c “account owners.” A query space 310-b may be associated with “Opportunities”-type documents, and may include an embedded query 305-d “forecasted revenue for next year,” an embedded query 305-e “top prospects,” and an embedded query 305-f “deals by stages.” In addition, a query space 310-c may be associated with “Leads”-type documents, which may include an embedded query 305-g “best lead sources,” and a query space 305-h reciting “number of leads.”

Each query space 310 corresponding to a given data object may include all possible relevant embedded queries 305 for that data object, excluding an embedding of the data object itself. In some examples, the system may increase query diversity via various techniques, including shuffling, subset sampling, grounding, and temperature variations, which may result in deletion, replacement, masking, and other filtering of documents.

When the system receives a natural language query 315 from a user, the system may embed and vectorize the natural language query 315 and compare the embedded natural language query 315 to the query spaces 310. For example, if the natural language query 315 is for “revenue opportunities,” the embedding for the natural language query 315 may be semantically closest to the query 305-d “forecasted revenue for next year,” which is a part of the “Opportunities” query space 310-b. As a result, the system may retrieve the “Opportunities” document rather than an “Accounts” and “Leads” document.

FIG. 4 shows an example of a document retrieval 400 that supports semantic searching of structured data using generated query spaces in accordance with aspects of the present disclosure. The document retrieval 400 may implement or be implemented by aspects of the data processing system 100, the computing architecture 200, and the embedded queries 300. For example, the document retrieval 400 may be based on comparing a natural language query from a user to embedded queries and query spaces associated with a data object (e.g., a document).

In some examples, a set of candidate natural language queries generated by an LLM may be embedded into a set of vectors. Each embedded query 405 may belong to a query space 410, where a query space 410 may include a collection of embedded queries 405 corresponding to a given data object. For example, an embedded query 405-a and an embedded query 405-b may correspond to a query space 410-a, and an embedded query 405-c, an embedded query 405-d, and an embedded query 405-e may correspond to a query space 410-b.

As described herein, a system may receive a natural language query from a user and embed the query in a vector such that it may be compared to the embedded queries 405 of the query spaces 410. The natural language query may be embedded as an embedded query 415. Rather than compare the embedded query 415 against a single document embedding (e.g., an embedding of the data object itself), the embedded query 415 may be compared against multiple embedded queries 405 or the query spaces 410 (e.g., hyperplanes) defined by the embedded queries 405. That is, since the data object is represented by a collection of embedded queries 405 rather than a single embedded query 405, the system may compare the embedded query 415 with a hyperplane corresponding to the data object to improve document retrieval or recall.

In some examples, the system may compare the embedded query 415 to each of the embedded queries 405 (of one or multiple query spaces 410) based on measuring a distance between the embedded query 415 and a nearest neighbor among the embedded queries 405. The system may measure the distances between the queries in this way based on the embedding space being semantically interpolative. For example, the system may compare the embedded query 415 to the embedded query 405-c, which may be the closest embedded query 405 within the query space 410-b. Alternatively, the system may compare the embedded query 415 and any of the embedded queries 405.

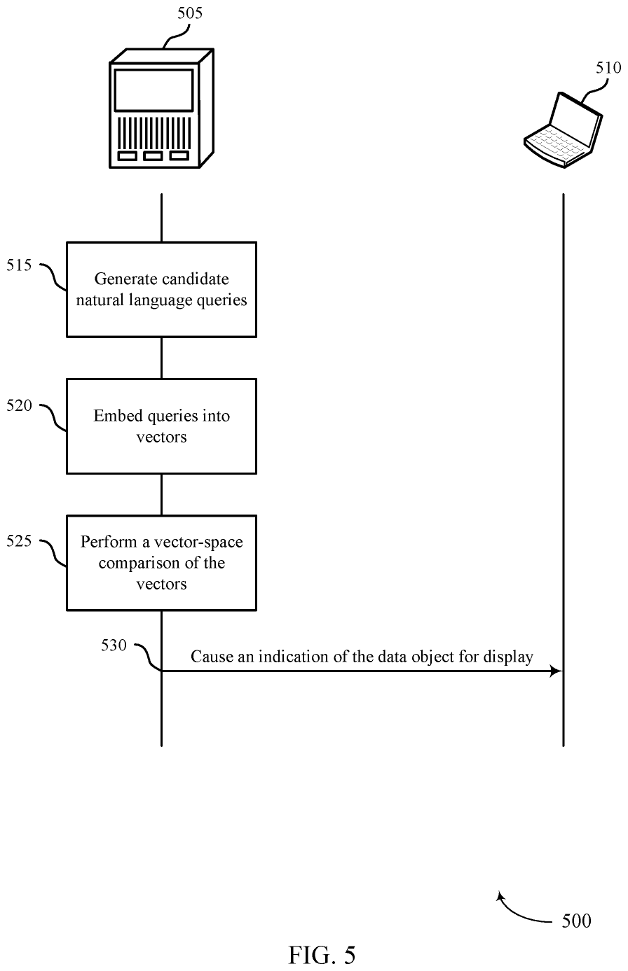

FIG. 5 shows an example of a process flow 500 that supports semantic searching of structured data using generated query spaces in accordance with aspects of the present disclosure. The process flow 500 may implement or be implemented by aspects of the data processing system 100 or the computing architecture 200. For example, the process flow 500 may include an application server 505 and a user device 510, which may be examples of corresponding services and platforms described herein. In the following description of the process flow 500, operations between the application server 505 and the user device 510 may be performed in a different order or at a different time than as shown. Additionally, or alternatively, some operations may be omitted from the process flow 500, and other operations may be added to the process flow 500. The process flow 500 may support techniques for semantic searching of structured data using generated query spaces.

At 515, the application server 505 may generate a set of candidate natural language queries that correspond to a data object by inputting a set of metadata associated with the data object into an LLM. The candidate natural language queries may represent potential and plausible queries that a user may indicate to retrieve the data object.

At 520, the application server 505 may embed the set of candidate natural language queries into a first set of vectors and a natural language query received from a user into a second vector. In some examples, a collection of embedded vectors belonging to the data object may be interpreted as a query space.

At 525, the application server 505 may perform a vector-space comparison based on measuring a distance between the second vector to a nearest neighbor among the first set of vectors, measuring a distance between the second vector and a hyperplane associated with the first set of vectors, or both. In this way, the application server 505 may identify one of the first set of vectors which is most closely related to the second vector, and may identify the data object corresponding to the query space in which the first vector is located.

At 530, the application server 505 may cause for display, at the user device 510, an indication of the data object as being related to the natural language query received from the user based on the vector-space comparison of the second vector to the first set of vectors. That is, the data object may be associated with the user's natural language query, which may be determined based on comparing the embedded candidate natural language queries to the embedded natural language query from the user.

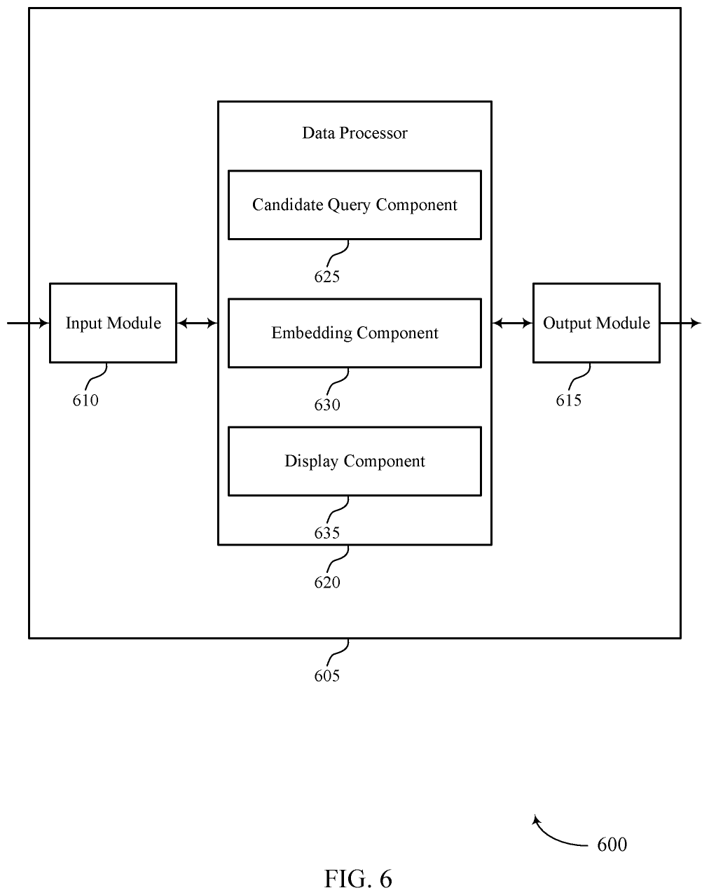

FIG. 6 shows a block diagram 600 of a device 605 that supports semantic searching of structured data using generated query spaces in accordance with aspects of the present disclosure. The device 605 may include an input module 610, an output module 615, and a data processor 620. The device 605, or one or more components of the device 605 (e.g., the input module 610, the output module 615, the data processor 620), may include at least one processor, which may be coupled with at least one memory, to support the described techniques. Each of these components may be in communication with one another (e.g., via one or more buses).

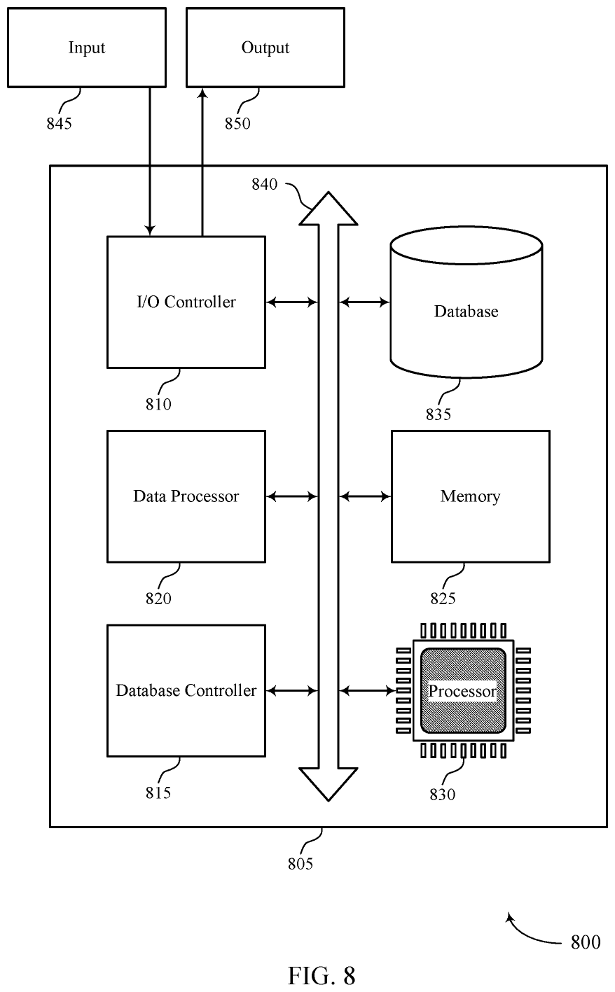

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the data processor 620 to support semantic searching of structured data using generated query spaces. In some cases, the input module 610 may be a component of an input/output (I/O) controller 810 as described with reference to FIG. 8.

The output module 615 may manage output signals for the device 605. For example, the output module 615 may receive signals from other components of the device 605, such as the data processor 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the data processor 620 may include a candidate query component 625, an embedding component 630, a display component 635, or any combination thereof. In some examples, the data processor 620, or various components thereof, may be configured to perform various operations (e.g., receiving, monitoring, transmitting) using or otherwise in cooperation with the input module 610, the output module 615, or both. For example, the data processor 620 may receive information from the input module 610, send information to the output module 615, or be integrated in combination with the input module 610, the output module 615, or both to receive information, transmit information, or perform various other operations as described herein.

The data processor 620 may support data processing in accordance with examples as disclosed herein. The candidate query component 625 may be configured to support generating a set of multiple candidate natural language queries that correspond to a data object by inputting a set of metadata associated with the data object into a LLM. The embedding component 630 may be configured to support embedding the set of multiple candidate natural language queries into a first set of vectors and a natural language query received from a user into a second vector. The display component 635 may be configured to support causing for display an indication of the data object as being related to the natural language query received from the user based on a vector-space comparison of the second vector to the first set of vectors.

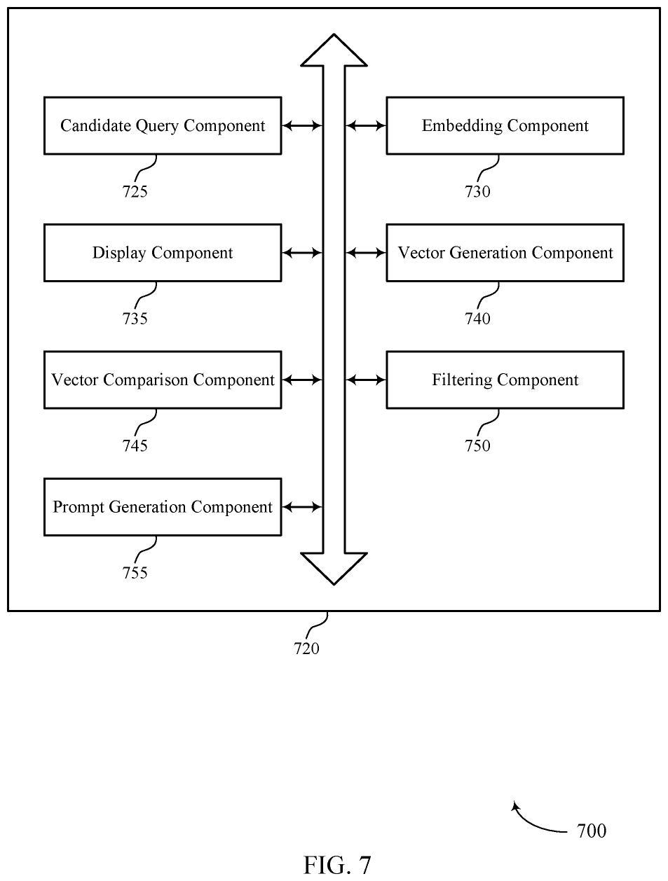

FIG. 7 shows a block diagram 700 of a data processor 720 that supports semantic searching of structured data using generated query spaces in accordance with aspects of the present disclosure. The data processor 720 may be an example of aspects of a data processor or a data processor 620, or both, as described herein. The data processor 720, or various components thereof, may be an example of means for performing various aspects of semantic searching of structured data using generated query spaces as described herein. For example, the data processor 720 may include a candidate query component 725, an embedding component 730, a display component 735, a vector generation component 740, a vector comparison component 745, a filtering component 750, a prompt generation component 755, or any combination thereof. Each of these components, or components of subcomponents thereof (e.g., one or more processors, one or more memories), may communicate, directly or indirectly, with one another (e.g., via one or more buses).

The data processor 720 may support data processing in accordance with examples as disclosed herein. The candidate query component 725 may be configured to support generating a set of multiple candidate natural language queries that correspond to a data object by inputting a set of metadata associated with the data object into a LLM. The embedding component 730 may be configured to support embedding the set of multiple candidate natural language queries into a first set of vectors and a natural language query received from a user into a second vector. The display component 735 may be configured to support causing for display an indication of the data object as being related to the natural language query received from the user based on a vector-space comparison of the second vector to the first set of vectors.

In some examples, the vector generation component 740 may be configured to support generating the first set of vectors and the second vector using an embedding model.

In some examples, to support causing for display the indication of the data object, the vector comparison component 745 may be configured to support performing the vector-space comparison based on measuring a distance between the second vector to a nearest neighbor among the first set of vectors, measuring a distance between the second vector and a hyperplane associated with the first set of vectors, or both.

In some examples, to support causing for display the indication of the data object, the vector comparison component 745 may be configured to support performing a comparison between the second vector and one or more vectors of the first set of vectors, where the indication of the data object is based on the comparison.

In some examples, the filtering component 750 may be configured to support removing one or more candidate natural language queries from the set of multiple candidate natural language queries based on applying consistency filtering, where the consistency filtering includes matching each candidate natural language query of the set of multiple candidate natural language queries to the data object.

In some examples, to support generating the set of multiple candidate natural language queries, the prompt generation component 755 may be configured to support generating a prompt indicating the set of metadata to the LLM, where the set of multiple candidate natural language queries is generated in accordance with the prompt.

In some examples, the vector generation component 740 may be configured to support storing the first set of vectors in a vector database. In some examples, the set of multiple candidate natural language queries includes one or more fragments of each candidate natural language query. In some examples, the set of metadata is of a first structured format or a second serialized format.

FIG. 8 shows a diagram of a system 800 including a device 805 that supports semantic searching of structured data using generated query spaces in accordance with aspects of the present disclosure. The device 805 may be an example of or include components of a device 605 as described herein. The device 805 may include components for bi-directional data communications including components for transmitting and receiving communications, such as a data processor 820, an I/O controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting semantic searching of structured data using generated query spaces). The processor 830 may be an example of a single processor or multiple processors. For example, the device 805 may include one or more processors 830.

The data processor 820 may support data processing in accordance with examples as disclosed herein. For example, the data processor 820 may be configured to support generating a set of multiple candidate natural language queries that correspond to a data object by inputting a set of metadata associated with the data object into a LLM. The data processor 820 may be configured to support embedding the set of multiple candidate natural language queries into a first set of vectors and a natural language query received from a user into a second vector. The data processor 820 may be configured to support causing for display an indication of the data object as being related to the natural language query received from the user based on a vector-space comparison of the second vector to the first set of vectors.

By including or configuring the data processor 820 in accordance with examples as described herein, the device 805 may support techniques for semantic searching of structured data using generated query spaces, which may improve computational efficiency, reduce memory and power consumption, improve querying accuracy and speed, and improve user experience.

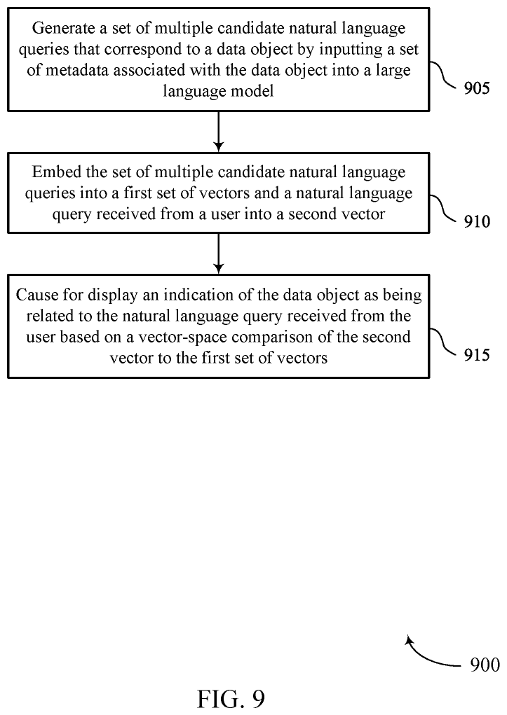

FIG. 9 shows a flowchart illustrating a method 900 that supports semantic searching of structured data using generated query spaces in accordance with aspects of the present disclosure. The operations of the method 900 may be implemented by a data processor or its components as described herein. For example, the operations of the method 900 may be performed by a data processor as described with reference to FIGS. 1 through 8. In some examples, a data processor may execute a set of instructions to control the functional elements of the data processor to perform the described functions. Additionally, or alternatively, the data processor may perform aspects of the described functions using special-purpose hardware.

At 905, the method may include generating a set of multiple candidate natural language queries that correspond to a data object by inputting a set of metadata associated with the data object into a LLM. The operations of 905 may be performed in accordance with examples as disclosed herein. In some examples, aspects of the operations of 905 may be performed by a candidate query component 725 as described with reference to FIG. 7.

At 910, the method may include embedding the set of multiple candidate natural language queries into a first set of vectors and a natural language query received from a user into a second vector. The operations of 910 may be performed in accordance with examples as disclosed herein. In some examples, aspects of the operations of 910 may be performed by an embedding component 730 as described with reference to FIG. 7.

At 915, the method may include causing for display an indication of the data object as being related to the natural language query received from the user based on a vector-space comparison of the second vector to the first set of vectors. The operations of 915 may be performed in accordance with examples as disclosed herein. In some examples, aspects of the operations of 915 may be performed by a display component 735 as described with reference to FIG. 7.

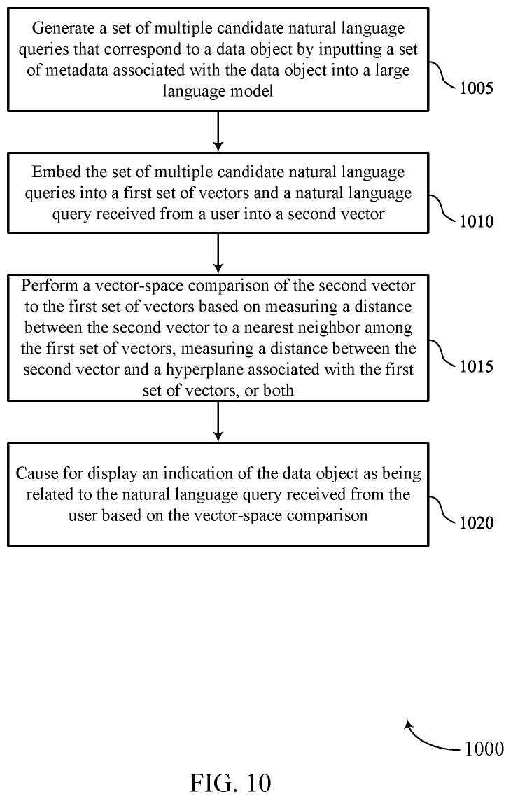

FIG. 10 shows a flowchart illustrating a method 1000 that supports semantic searching of structured data using generated query spaces in accordance with aspects of the present disclosure. The operations of the method 1000 may be implemented by a data processor or its components as described herein. For example, the operations of the method 1000 may be performed by a data processor as described with reference to FIGS. 1 through 8. In some examples, a data processor may execute a set of instructions to control the functional elements of the data processor to perform the described functions. Additionally, or alternatively, the data processor may perform aspects of the described functions using special-purpose hardware.

At 1005, the method may include generating a set of multiple candidate natural language queries that correspond to a data object by inputting a set of metadata associated with the data object into a LLM. The operations of 1005 may be performed in accordance with examples as disclosed herein. In some examples, aspects of the operations of 1005 may be performed by a candidate query component 725 as described with reference to FIG. 7.

At 1010, the method may include embedding the set of multiple candidate natural language queries into a first set of vectors and a natural language query received from a user into a second vector. The operations of 1010 may be performed in accordance with examples as disclosed herein. In some examples, aspects of the operations of 1010 may be performed by an embedding component 730 as described with reference to FIG. 7.

At 1015, the method may include performing a vector-space comparison of the second vector to the first set of vectors based on measuring a distance between the second vector to a nearest neighbor among the first set of vectors, measuring a distance between the second vector and a hyperplane associated with the first set of vectors, or both. The operations of 1015 may be performed in accordance with examples as disclosed herein. In some examples, aspects of the operations of 1015 may be performed by a vector comparison component 745 as described with reference to FIG. 7.

At 1020, the method may include causing for display an indication of the data object as being related to the natural language query received from the user based on the vector-space comparison. The operations of 1020 may be performed in accordance with examples as disclosed herein. In some examples, aspects of the operations of 1020 may be performed by a display component 735 as described with reference to FIG. 7.

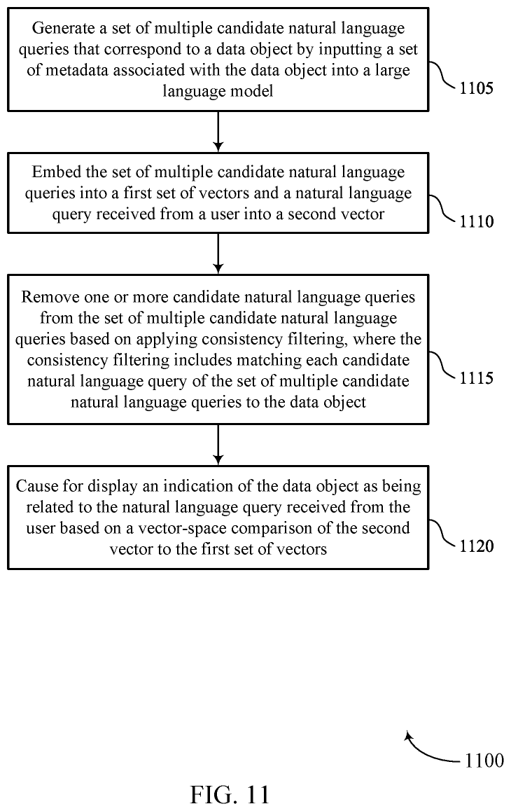

FIG. 11 shows a flowchart illustrating a method 1100 that supports semantic searching of structured data using generated query spaces in accordance with aspects of the present disclosure. The operations of the method 1100 may be implemented by a data processor or its components as described herein. For example, the operations of the method 1100 may be performed by a data processor as described with reference to FIGS. 1 through 8. In some examples, a data processor may execute a set of instructions to control the functional elements of the data processor to perform the described functions. Additionally, or alternatively, the data processor may perform aspects of the described functions using special-purpose hardware.

At 1105, the method may include generating a set of multiple candidate natural language queries that correspond to a data object by inputting a set of metadata associated with the data object into a LLM. The operations of 1105 may be performed in accordance with examples as disclosed herein. In some examples, aspects of the operations of 1105 may be performed by a candidate query component 725 as described with reference to FIG. 7.

At 1110, the method may include embedding the set of multiple candidate natural language queries into a first set of vectors and a natural language query received from a user into a second vector. The operations of 1110 may be performed in accordance with examples as disclosed herein. In some examples, aspects of the operations of 1110 may be performed by an embedding component 730 as described with reference to FIG. 7.

At 1115, the method may include removing one or more candidate natural language queries from the set of multiple candidate natural language queries based on applying consistency filtering, where the consistency filtering includes matching each candidate natural language query of the set of multiple candidate natural language queries to the data object. The operations of 1115 may be performed in accordance with examples as disclosed herein. In some examples, aspects of the operations of 1115 may be performed by a filtering component 750 as described with reference to FIG. 7.

At 1120, the method may include causing for display an indication of the data object as being related to the natural language query received from the user based on a vector-space comparison of the second vector to the first set of vectors. The operations of 1120 may be performed in accordance with examples as disclosed herein. In some examples, aspects of the operations of 1120 may be performed by a display component 735 as described with reference to FIG. 7.

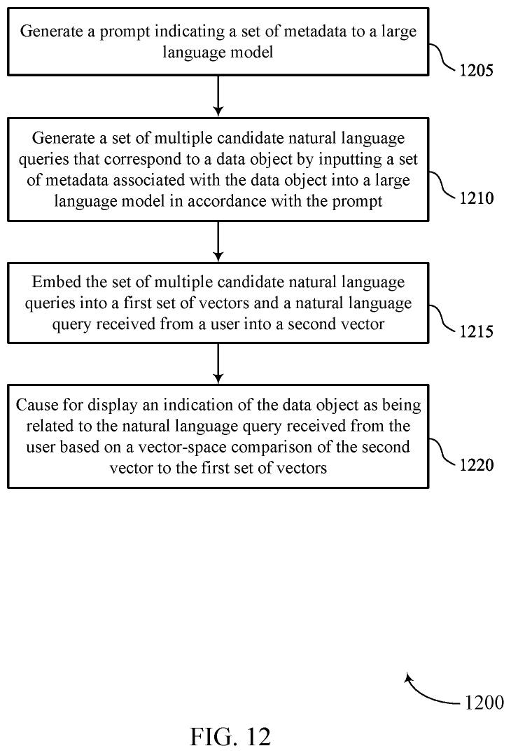

FIG. 12 shows a flowchart illustrating a method 1200 that supports semantic searching of structured data using generated query spaces in accordance with aspects of the present disclosure. The operations of the method 1200 may be implemented by a data processor or its components as described herein. For example, the operations of the method 1200 may be performed by a data processor as described with reference to FIGS. 1 through 8. In some examples, a data processor may execute a set of instructions to control the functional elements of the data processor to perform the described functions. Additionally, or alternatively, the data processor may perform aspects of the described functions using special-purpose hardware.

At 1205, the method may include generating a prompt indicating a set of metadata to an LLM. The operations of 1205 may be performed in accordance with examples as disclosed herein. In some examples, aspects of the operations of 1205 may be performed by a prompt generation component 755 as described with reference to FIG. 7.

At 1210, the method may include generating a set of multiple candidate natural language queries that correspond to a data object by inputting a set of metadata associated with the data object into a LLM in accordance with the prompt. The operations of 1210 may be performed in accordance with examples as disclosed herein. In some examples, aspects of the operations of 1210 may be performed by a candidate query component 725 as described with reference to FIG. 7.

At 1215, the method may include embedding the set of multiple candidate natural language queries into a first set of vectors and a natural language query received from a user into a second vector. The operations of 1215 may be performed in accordance with examples as disclosed herein. In some examples, aspects of the operations of 1215 may be performed by an embedding component 730 as described with reference to FIG. 7.

At 1220, the method may include causing for display an indication of the data object as being related to the natural language query received from the user based on a vector-space comparison of the second vector to the first set of vectors. The operations of 1220 may be performed in accordance with examples as disclosed herein. In some examples, aspects of the operations of 1220 may be performed by a display component 735 as described with reference to FIG. 7.

A method for data processing by an apparatus is described. The method may include generating a set of multiple candidate natural language queries that correspond to a data object by inputting a set of metadata associated with the data object into a LLM, embedding the set of multiple candidate natural language queries into a first set of vectors and a natural language query received from a user into a second vector, and causing for display an indication of the data object as being related to the natural language query received from the user based on a vector-space comparison of the second vector to the first set of vectors

An apparatus for data processing is described. The apparatus may include one or more memories storing processor executable code, and one or more processors coupled with the one or more memories. The one or more processors may individually or collectively be operable to execute the code to cause the apparatus to generate a set of multiple candidate natural language queries that correspond to a data object by inputting a set of metadata associated with the data object into a LLM, embed the set of multiple candidate natural language queries into a first set of vectors and a natural language query received from a user into a second vector, and cause for display an indication of the data object as being related to the natural language query received from the user based on a vector-space comparison of the second vector to the first set of vectors.

Another apparatus for data processing is described. The apparatus may include means for generating a set of multiple candidate natural language queries that correspond to a data object by inputting a set of metadata associated with the data object into a LLM, means for embedding the set of multiple candidate natural language queries into a first set of vectors and a natural language query received from a user into a second vector, and means for causing for display an indication of the data object as being related to the natural language query received from the user based on a vector-space comparison of the second vector to the first set of vectors.

A non-transitory computer-readable medium storing code for data processing is described. The code may include instructions executable by one or more processors to generate a set of multiple candidate natural language queries that correspond to a data object by inputting a set of metadata associated with the data object into a LLM, embed the set of multiple candidate natural language queries into a first set of vectors and a natural language query received from a user into a second vector, and cause for display an indication of the data object as being related to the natural language query received from the user based on a vector-space comparison of the second vector to the first set of vectors.

Some examples of the method, apparatus, and non-transitory computer-readable medium described herein may further include operations, features, means, or instructions for generating the first set of vectors and the second vector using an embedding model.

In some examples of the method, apparatus, and non-transitory computer-readable medium described herein, causing for display the indication of the data object may include operations, features, means, or instructions for performing the vector-space comparison based on measuring a distance between the second vector to a nearest neighbor among the first set of vectors, measuring a distance between the second vector and a hyperplane associated with the first set of vectors, or both.

In some examples of the method, apparatus, and non-transitory computer-readable medium described herein, causing for display the indication of the data object may include operations, features, means, or instructions for performing a comparison between the second vector and one or more vectors of the first set of vectors, where the indication of the data object may be based on the comparison.

Some examples of the method, apparatus, and non-transitory computer-readable medium described herein may further include operations, features, means, or instructions for removing one or more candidate natural language queries from the set of multiple candidate natural language queries based on applying consistency filtering, where the consistency filtering includes matching each candidate natural language query of the set of multiple candidate natural language queries to the data object.

In some examples of the method, apparatus, and non-transitory computer-readable medium described herein, generating the set of multiple candidate natural language queries may include operations, features, means, or instructions for generating a prompt indicating the set of metadata to the LLM, where the set of multiple candidate natural language queries may be generated in accordance with the prompt.

Some examples of the method, apparatus, and non-transitory computer-readable medium described herein may further include operations, features, means, or instructions for storing the first set of vectors in a vector database.

In some examples of the method, apparatus, and non-transitory computer-readable medium described herein, the set of multiple candidate natural language queries includes one or more fragments of each candidate natural language query.

In some examples of the method, apparatus, and non-transitory computer-readable medium described herein, the set of metadata may be of a first structured format or a second serialized format.

The following provides an overview of aspects of the present disclosure:

Aspect 1: A method for data processing, comprising: generating a plurality of candidate natural language queries that correspond to a data object by inputting a set of metadata associated with the data object into a LLM: embedding the plurality of candidate natural language queries into a first set of vectors and a natural language query received from a user into a second vector; and causing for display an indication of the data object as being related to the natural language query received from the user based at least in part on a vector-space comparison of the second vector to the first set of vectors.

Aspect 2: The method of aspect 1, further comprising: generating the first set of vectors and the second vector using an embedding model.

Aspect 3: The method of any of aspects 1 through 2, wherein causing for display the indication of the data object further comprises: performing the vector-space comparison based at least in part on measuring a distance between the second vector to a nearest neighbor among the first set of vectors, measuring a distance between the second vector and a hyperplane associated with the first set of vectors, or both.

Aspect 4: The method of any of aspects 1 through 3, wherein causing for display the indication of the data object further comprises: performing a comparison between the second vector and one or more vectors of the first set of vectors, wherein the indication of the data object is based at least in part on the comparison.

Aspect 5: The method of any of aspects 1 through 4, further comprising: removing one or more candidate natural language queries from the plurality of candidate natural language queries based at least in part on applying consistency filtering, wherein the consistency filtering comprises matching each candidate natural language query of the plurality of candidate natural language queries to the data object.

Aspect 6: The method of any of aspects 1 through 5, wherein generating the plurality of candidate natural language queries further comprises: generating a prompt indicating the set of metadata to the LLM, wherein the plurality of candidate natural language queries is generated in accordance with the prompt.

Aspect 7: The method of any of aspects 1 through 6, further comprising: storing the first set of vectors in a vector database.

Aspect 8: The method of any of aspects 1 through 7, wherein the plurality of candidate natural language queries comprises one or more fragments of each candidate natural language query.

Aspect 9: The method of any of aspects 1 through 8, wherein the set of metadata is of a first structured format or a second serialized format.

Aspect 10: An apparatus for data processing, comprising one or more memories storing processor-executable code, and one or more processors coupled with the one or more memories and individually or collectively operable to execute the code to cause the apparatus to perform a method of any of aspects 1 through 9.

Aspect 11: An apparatus for data processing, comprising at least one means for performing a method of any of aspects 1 through 9.

Aspect 12: A non-transitory computer-readable medium storing code for data processing, the code comprising instructions executable by one or more processors to perform a method of any of aspects 1 through 9.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a.” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components.” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
generating a plurality of candidate natural language queries that correspond to a data object by inputting a set of metadata associated with the data object into a large language model;
embedding the plurality of candidate natural language queries into a first set of vectors and a natural language query received from a user into a second vector; and
causing for display an indication of the data object as being related to the natural language query received from the user based at least in part on a vector-space comparison of the second vector to the first set of vectors.

2. The method of claim 1, further comprising:
generating the first set of vectors and the second vector using an embedding model.

3. The method of claim 1, wherein causing for display the indication of the data object further comprises:
performing the vector-space comparison based at least in part on measuring a distance between the second vector to a nearest neighbor among the first set of vectors, measuring a distance between the second vector and a hyperplane associated with the first set of vectors, or both.

4. The method of claim 1, wherein causing for display the indication of the data object further comprises:
performing a comparison between the second vector and one or more vectors of the first set of vectors, wherein the indication of the data object is based at least in part on the comparison.

5. The method of claim 1, further comprising:
removing one or more candidate natural language queries from the plurality of candidate natural language queries based at least in part on applying consistency filtering, wherein the consistency filtering comprises matching each candidate natural language query of the plurality of candidate natural language queries to the data object.

6. The method of claim 1, wherein generating the plurality of candidate natural language queries further comprises:
generating a prompt indicating the set of metadata to the large language model, wherein the plurality of candidate natural language queries is generated in accordance with the prompt.

7. The method of claim 1, further comprising:
storing the first set of vectors in a vector database.

8. The method of claim 1, wherein the plurality of candidate natural language queries comprises one or more fragments of each candidate natural language query.

9. The method of claim 1, wherein the set of metadata is of a first structured format or a second serialized format.

10. An apparatus for data processing, comprising:
one or more memories storing processor-executable code; and
one or more processors coupled with the one or more memories and individually or collectively operable to execute the code to cause the apparatus to:
generate a plurality of candidate natural language queries that correspond to a data object by inputting a set of metadata associated with the data object into a large language model;
embed the plurality of candidate natural language queries into a first set of vectors and a natural language query received from a user into a second vector; and
cause for display an indication of the data object as being related to the natural language query received from the user based at least in part on a vector-space comparison of the second vector to the first set of vectors.

11. The apparatus of claim 10, wherein the one or more processors are individually or collectively further operable to execute the code to cause the apparatus to:
generate the first set of vectors and the second vector using an embedding model.

12. The apparatus of claim 10, wherein, to cause for display the indication of the data object, the one or more processors are individually or collectively further operable to execute the code to cause the apparatus to:
perform the vector-space comparison based at least in part on measuring a distance between the second vector to a nearest neighbor among the first set of vectors, measuring a distance between the second vector and a hyperplane associated with the first set of vectors, or both.

13. The apparatus of claim 10, wherein, to cause for display the indication of the data object, the one or more processors are individually or collectively further operable to execute the code to cause the apparatus to:
perform a comparison between the second vector and one or more vectors of the first set of vectors, wherein the indication of the data object is based at least in part on the comparison.

14. The apparatus of claim 10, wherein the one or more processors are individually or collectively further operable to execute the code to cause the apparatus to:
remove one or more candidate natural language queries from the plurality of candidate natural language queries based at least in part on applying consistency filtering, wherein the consistency filtering comprises matching each candidate natural language query of the plurality of candidate natural language queries to the data object.

15. The apparatus of claim 10, wherein, to generate the plurality of candidate natural language queries, the one or more processors are individually or collectively further operable to execute the code to cause the apparatus to:
generate a prompt indicating the set of metadata to the large language model, wherein the plurality of candidate natural language queries is generated in accordance with the prompt.

16. The apparatus of claim 10, wherein the one or more processors are individually or collectively further operable to execute the code to cause the apparatus to:
store the first set of vectors in a vector database.

17. The apparatus of claim 10, wherein the plurality of candidate natural language queries comprises one or more fragments of each candidate natural language query.

18. The apparatus of claim 10, wherein the set of metadata is of a first structured format or a second serialized format.

19. A non-transitory computer-readable medium storing code for data processing, the code comprising instructions executable by one or more processors to:
generate a plurality of candidate natural language queries that correspond to a data object by inputting a set of metadata associated with the data object into a large language model;
embed the plurality of candidate natural language queries into a first set of vectors and a natural language query received from a user into a second vector; and
cause for display an indication of the data object as being related to the natural language query received from the user based at least in part on a vector-space comparison of the second vector to the first set of vectors.

20. The non-transitory computer-readable medium of claim 19, wherein the instructions are further executable by the one or more processors to:
generate the first set of vectors and the second vector using an embedding model.
